(19) United States
(12) Patent Application Publication
(10) Pub. No.: US 2002/0196504 A1
(43) Pub. Date: Dec. 26, 2002

(54) Gain equalizer for two-way transmission and monitor circuit for two-way transmission

(75) Inventor: Katsuyuki Mino, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation

(21) Appl. No.: 10/156,690

(22) Filed: May 29, 2002

(30) Foreign Application Priority Data
May 29, 2001 (JP) 2001-161051
Jun. 14, 2001 (JP) 2001-179659

(51) Int. Cl. H04B 10/00

(52) U.S. Cl. 359/161

(57) ABSTRACT

A gain equalizer for two-way transmission includes first and second circulators which are common to upstream and downstream signals, and which are provided in series along an optical transmission path through which an optical signal is transmitted in two directions and partially constitute an upstream path and a downstream path, and a gain equalization circuit which has been inserted into at least one of the upstream and downstream paths and which equalizes the characteristics of all of channels of WDM (wavelength division multiplexing) signals passed therethrough.

### FIELD OF THE INVENTION

The invention relates to a gain equalizer for two-way transmission and a monitor circuit for two-way transmission, and more particularly to a gain equalizer for two-way transmission, which can equalize the characteristics of individual channels of upstream and downstream WDM signals in a single transmission path common to upstream and downstream signals, and a monitor circuit for two-way transmission which can monitor an identical optical transmission path common to upstream and downstream signals.

### BACKGROUND OF THE INVENTION

For optical communication by two-way transmission using an optical fiber, an optical fiber dedicated for upstream signals and an optical fiber dedicated for downstream signals have hitherto been provided. When a single optical fiber is common to upstream and downstream signals, the number of necessary optical fibers can be reduced. Accordingly, the adoption of two-way transmission using a single optical fiber common to upstream and downstream signals is considered. In, this case, an issue is the provision of a repeater and a monitor circuit. In the use of a single optical fiber common to the upstream and downstream signals, the repeater and the monitor circuit cannot be simply installed in the single optical fiber, because the flow of the optical signal is directional.

To solve this problem, Japanese Patent Laid-Open No. 291525/1992 discloses a two-way repeater. In this two-way repeater, first and second optical multiplexer/demultiplexer for demultiplexing input light into two parts or multiplexing two light parts into one light are provided in a transmission path, and a circuit comprising a repeater and an optical isolator connected in series is inserted into each of upstream and downstream branch paths constituted by the first optical multiplexer/demultiplexer and the second optical multiplexer/demultiplexer to insert a repeater into each of the upstream and downstream paths. Japanese patent Laid-Open No. 23628/1992 discloses an optical repeater wherein an optical amplifier is used instead of the repeater disclosed in Japanese patent Laid-Open No. 291525/1992. The above construction can realize two-way transmission through a single optical fiber.

Japanese Patent Laid-Open No. 268600/1994 discloses a two-way repeater. In this two-way repeater, first and second directional couplers for demultiplexing input light into two parts or multiplexing two light parts into one light are provided in a transmission path, and an optical amplifier is inserted into each of upstream and downstream branch paths constituted by the first and second directional couplers so that the optical amplifier can be functioned in each of the upstream and downstream paths. Thus, a two-way repeater having a simple construction is realized, and a trouble, which has occurred around and within the optical repeater, can be distinguished. In Japanese Patent No. 3052598, optical circulators are used instead of the first and second directional couplers in the two-way repeater disclosed in Japanese Patent Laid-Open No. 268600/1994, and a semiconductor laser module construction is adopted in the optical amplifier to prevent a deterioration in optical signals during transmission caused by oscillation or deformation of signals.

According to conventional equipment for two-way transmission, however, when a plurality of optical repeaters are provided within optical transmission paths, even in the case of input in a horizontal spectrum, in the course of the passage of WDM (wavelength division multiplexing) signals are passed therethrough, the characteristics of the optical repeaters affect the spectrum and this provides the characteristics of the output spectrum as shown in FIG. 1.

Even when a horizontal spectrum is input into the first optical repeater, for example, after the passage of 5 to 10 optical repeaters, as shown in FIG. 1, the characteristics are such that the optical intensity varies from wavelength to wavelength of WDM signals. This is attributable to the fact that the loss and the like of an optical fiber (EDF: erbium-doped fiber) constituting the optical amplifier vary depending upon the wavelength. In order to render the characteristics of all of channels of the WDM signals identical, every several optical repeaters, the spectrum should be returned to a horizontal state, because a deterioration in characteristics becomes significant when the signal has passed through several optical repeaters. In the prior art techniques, however, the passed signal is merely optically amplified, and the spectral characteristics of WDM signals cannot be improved.

Meanwhile, in communication using an optical transmission path using an optical fiber or the like, for example, whether or not signals are surely transmitted to a repeater and the like, or whether or not there is breaking or the like in the transmission path, should be monitored. Unlike metal conductors, however, this is not easy. Optical fiber communications are classified into one-way transmission and two-way transmission. The two-way transmission is carried out by two methods. One of the methods is to use a single optical fiber while performing switching between use for upstream signals and use for downstream signals, and the other is to assign dedicated optical fibers respectively to upstream and downstream paths.

In optical fiber transmission, Japanese Patent Laid-Open No. 225116/1999 proposes a circuit for monitoring a repeater. A fold-back circuit, which is a circuit for detouring an optical signal with a specific wavelength sent from an upstream or downstream terminal station by a repeater to return the signal to the sending station, is built in a repeater provided along a transmission path. An optical band-pass filter (optical BPF), which permits only a wavelength dedicated for the transmission of a monitor signal to be passed therethrough, is provided within the path. When the level of amplification has been lowered or when the delay time of the optical BPF has been increased, the fold-back wavelength signal is delayed to detect this fact. A lowering in the level of the fold-back wavelength signal from the subsequent stage repeater indicates that the optical fiber in the previous stage has been broken. Further, for example, the malfunction of the amplifier in the repeater, the breaking of the optical fiber, and the malfunction of the optical BPF can be judged based on the level and state of spectrum of the fold-back signal.

The conventional monitor circuit for two-way transmission is on the premise that a transmission path dedicated for upstream signals and a transmission path dedicated for downstream signals are provided. Therefore, conventional monitor circuit for two-way transmission cannot be applied to the monitoring of two-way communication wherein an identical optical fiber is used for both upstream and downstream signals.

### SUMMARY OF THE INVENTION

Accordingly, it is an object of the invention to provide a gain equalizer for two-way transmission which can render the characteristics of all channels of WDM signals in a repeater identical.

It is another object of the invention to provide a monitor circuit for two-way transmission which can realize the monitoring of an optical transmission path common to upstream and downstream signals.

According to the first feature of the invention, a gain equalizer for two-way transmission comprises; first and second circulators which are common to upstream and downstream signals, are provided in series along an optical transmission path through which an optical signal is transmitted in two directions and partially constitute an upstream path and a downstream path; and a gain equalization circuit which has been inserted into at least one of the upstream and downstream paths and equalize the characteristics of all of channels of WDM (wavelength division multiplexing) signals passed therethrough.

According to this construction, the gain equalizer inserted into at least one of the upstream and downstream paths provided between the first and second circulators which are provided in series along the optical transmission path functions to return the spectrum of all channels of WDM signals to a horizontal state and to recover the channel characteristics deteriorated by the optical repeater to the state found at the time of input. Therefore, even when the output spectrum of the optical repeater in a system using an identical fiber causes a difference in optical intensity between channels, the characteristics of all channels of WDM signals can be rendered identical.

According to the second feature of the invention, a gain equalizer for two-way transmission comprises: first and second optical couplers which are common to signals from upstream and downstream sides, are provided in series along an optical transmission path through which an optical signal is transmitted in two directions and partially constitute an upstream path and a downstream path; a gain equalization circuit which has been inserted into at least one of the upstream and downstream paths and equalizes the characteristics of all of channels of WDM (wavelength division multiplexing) signals passed therethrough; a first optical isolator inserted into the upstream path; and a second optical isolator inserted into the downstream path.

According to this construction, the first optical isolator and the second optical isolator provided respectively in the upstream path and the downstream path provided between the first and second optical couplers, which are provided in series along the optical transmission path, prevents an optical signal from entering from the opposite direction and constitute the path dedicated for upstream signals and the path dedicated for downstream signals. Further, the gain equalizer, which has been inserted into at least one of the upstream path and the downstream path, functions to return the spectrum of all channels of WDM signals to a horizontal state and to recover the channel characteristics deteriorated by the optical repeater to the state found at the time of input. Therefore, even when the output spectrum of the optical repeater in a system using an identical fiber causes a difference in optical intensity between channels, the characteristics of all channels of WDM signals can be rendered identical.

According to the third feature of the invention, a monitor circuit for two-way transmission comprises: first and second optical circulators which are common to upstream and downstream signals and are inserted in series along an optical transmission path through which an optical signal is transmitted in two directions and, at a predetermined time, a monitor signal is transmitted; first and second optical couplers which are provided in parallel between the first and second optical circulators and are inserted respectively into an upstream transmission path and a downstream transmission path; an optical transmission path for coupler connection which is connected between the first and second optical couplers to constitute a bypass path; and a wavelength filter which is connected to the first optical coupler or the second optical coupler and reflects light with the wavelength of the monitor signal.

According to this construction, the monitor signal, sent from the sending station, which has entered the first (or second) optical circulator, enters the wavelength filter through the first (or second) optical coupler. The monitor signal reflected from the wavelength filter is returned to the first (or second) optical coupler, enters the second (or first) optical coupler, and is then returned to the sending station through the initially introduced optical circulator, where the signal is used for judgment of the monitor. This can realize the monitoring in two-way communication using an identical optical transmission path common to upstream and downstream signals.

According to the fourth feature of the invention, a monitor circuit for two-way transmission comprises: first and second optical circulators which are common to upstream and downstream signals and are inserted in series along an optical transmission path through which an optical signal is transmitted in two directions and, at a predetermined time, a monitor signal is transmitted; first and second optical couplers which are provided in parallel between the first and second optical circulators and are inserted respectively into an upstream transmission path and a downstream transmission path; an optical attenuator provided between the first and second optical couplers; and first and second wavelength filters which are connected respectively to the first and second optical couplers and reflect light with the wavelength of the monitor signal.

According to this construction, the monitor signal, sent from the sending station, which has entered the first optical circulator, enters the first wavelength filter through the first optical coupler. The monitor signal reflected from the wavelength filter is returned to the first optical coupler, enters the second optical coupler through the optical attenuator, and is then returned to the first circulator. Likewise, the monitor signal, sent from the sending station, which has entered the second optical circulator, enters the second wavelength filter through the second optical coupler. The monitor signal reflected from this wavelength filter is returned to the second optical coupler, enters the first optical coupler through the optical attenuator, and is then returned to the second optical circulator. The monitor signal returned to the first or second optical circulator is returned to the sending station, where the signal is used for judgment of the monitor. This can realize the monitoring in two-way communication using an identical optical transmission path common to upstream and downstream signals.

According to the fifth feature of the invention, a monitor circuit for two-way transmission comprises: first and second optical couplers which are common to upstream and downstream signals and are inserted in series along an optical transmission path through which an optical signal is transmitted in two directions and, at a predetermined time, a monitor signal is transmitted; third and fourth optical couplers which are provided in parallel between the first and second optical circulators and are inserted respectively into an upstream transmission path and a downstream transmission path; an optical transmission path for coupler connection which is connected between the first and second optical couplers to constitute a bypass path; a first optical isolator inserted into between the third optical coupler and the second optical coupler; a second optical isolator inserted into between the fourth optical coupler and the first optical coupler; first and second optical attenuators connected respectively to the third optical coupler and the fourth optical coupler; and first and second wavelength filters which are connected respectively to the first and second optical attenuator and reflect light with the wavelength of the monitor signal.

According to this construction, the signal other than the monitor signal sent from the sending station, which has entered the first optical coupler, is transmitted through the third optical coupler and the first optical isolator to the second optical coupler. The monitor signal from the sending station, which has entered the first optical circulator, enters the first wavelength filter through a path of first optical coupler→third optical coupler→first optical attenuator and is reflected, is then returned to the third optical coupler, reaches the first optical coupler through a path of optical transmission path for coupler connection→fourth optical coupler→second optical isolator, and is then returned to the sending station. Further, the signal other than the monitor signal from other sending station, which has entered the second optical coupler, is transmitted to the first optical coupler through the fourth optical coupler and the second optical isolator. The monitor signal from the other sending station, which has entered the second optical circulator, enters the second wavelength filter through a path of second optical coupler→fourth optical coupler→second optical attenuator, is reflected, is then returned to the fourth optical coupler, reaches the second optical coupler through a path of optical transmission path for coupler connection→third optical coupler→first optical isolator, and is returned to the other sending station. This permits two-way monitoring in two-way communication using an identical optical transmission path common to upstream and downstream signals to be carried out while simultaneously transmitting upstream and downstream signals.

### BRIEF DESCRIPTION OF DRAWINGS

The invention will be explained in more detail in conjunction with the appended drawings, wherein:

FIG. 1 is a characteristic diagram of an output spectrum of a WDM signal after passage through a plurality of optical repeaters;

FIG. 2 is a block diagram showing a gain equalizer for two-way transmission according to the invention;

FIG. 3 is a block diagram showing a variant of the gain equalizer for two-way transmission according to the invention;

FIG. 4 is a block diagram showing a first embodiment of the application of the gain equalizer for two-way transmission according to the invention;

FIG. 5 is a block diagram showing a second embodiment of the application of the gain equalizer for two-way transmission according to the invention;

FIG. 6 is a block diagram showing another preferred embodiment of the invention:

FIG. 7 is a block diagram showing a monitor circuit for two-way transmission according to the invention;

FIG. 8 is a block diagram showing a variant of the monitor circuit for two-way transmission shown in FIG. 7;

FIG. 9 is a block diagram showing an embodiment of the application of the monitor circuit for two-way transmission according to the invention;

FIG. 10 is a block diagram showing a second preferred embodiment of the monitor circuit for two-way transmission according to the invention; and

FIG. 11 is a block diagram showing a third preferred embodiment of the monitor circuit for two-way transmission according to the invention.

### DESCRIPTION OF THE PREFERRED EMBODIMENTS

Preferred embodiments of the invention will be explained in conjunction with the accompanying drawings.

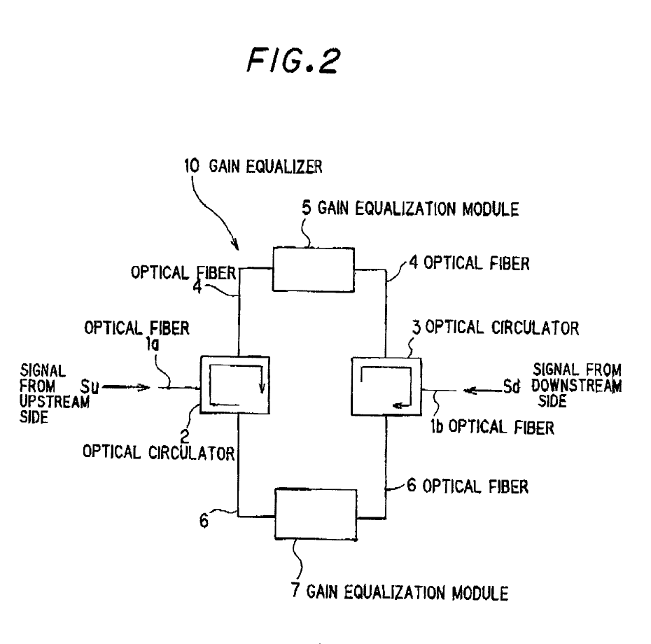

FIG. 2 shows a gain equalizer for two-way transmission according to the invention.

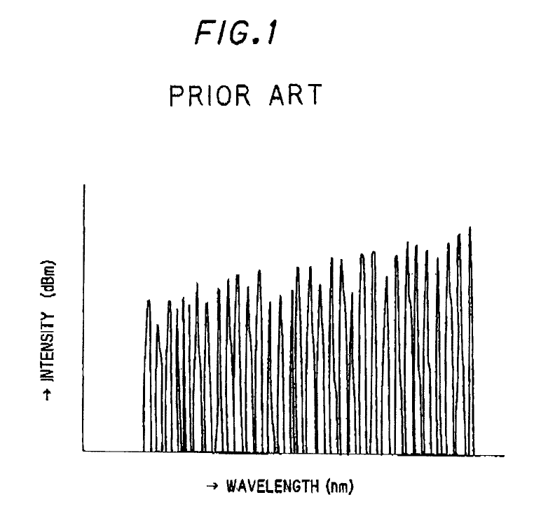

Optical circulators 2, 3 are connected to the end of optical fibers 1a, 1b. The optical circulators 2, 3 have an identical construction. The optical circulators 2, 3 each have one input/output port and, in addition, have one input port and one output port. A gain equalization module 5 as a gain equalization circuit is inserted into an optical fiber 4 connected between the output port of the optical circulator 2 and the input port of the optical circulator 3. A gain equalization module 7 is inserted into an optical fiber 6 connected between the input port of the optical circulator 2 and the output port of the optical circulator 3. Although the gain equalization module 5 and the gain equalization module 7 have identical construction and specifications, they are set so as to have characteristics opposite to characteristics shown in FIG. 1 (characteristics such that the optical intensity vary depending upon the wavelength of the WDM signal). Processing for varying the characteristics will be hereinafter referred to as gain equalization. The gain equalization modules 5, 7 are constructed using an optical filter or an optical grating which selects or reflects each wavelength of WDM signals. If necessary, an optical amplifier or an optical attenuator is provided in the gain equalization modules 5, 7.

Next, the operation of the gain equalizer for two-way transmission having a construction shown in FIG. 2 will be explained. At the outset, an embodiment, wherein a signal is introduced from the upstream side, will be explained. A signal Su (WDM signal) from the upstream side enters the optical circulator 2 and is sent from the optical circulator 2 to the gain equalization module 5 through the optical fiber 4. This gain equalization module 5 performs gain equalization so that the spectrum of all channels in the characteristic diagram in FIG. 1 is rendered identical. The gain equalized WDM signal is introduced into the optical circulator 3 through the optical fiber 4, is sent to an optical fiber 1b, and is transmitted to the downstream side.

Next, an embodiment, wherein a signal is introduced from the downstream side, will be explained. A signal Sd (WDM signal) from the downstream side enters the optical circulator 3 through the optical fiber 1b and is introduced from the optical circulator 3 into the gain equalization module 7 through the optical fiber 6. After predetermined gain equalization is carried out by this gain equalization module 7, the signal Sd enters the optical circulator 2 through the optical fiber 6, is sent to the optical fiber 1a, and is transmitted to the upstream side.

In the gain equalizer for two-way transmission having the above construction according to the invention, gain equalization for upstream signals and gain equalization for downstream signals in a single transmission path (optical fiber) can be carried out independently of each other, and uneven spectrum of the WDM signal can be corrected. The gain equalizer for two-way transmission according to the invention can be provided in the repeater and optionally in any desire position of the transmission path.

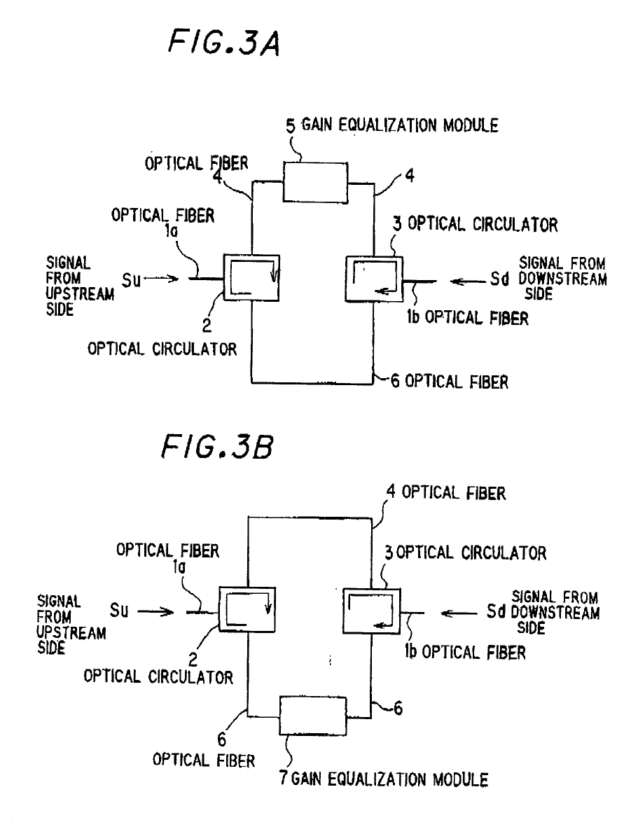

FIG. 3 shows a variant of the gain equalizer for two-way transmission according to the invention. In FIG. 2, the gain equalization module is provided on each of the upstream and downstream sides. The gain equalization module, however, may be provided on only the upstream side as shown in FIG. 3A, or may be provided on only the downstream side as shown in FIG. 3B.

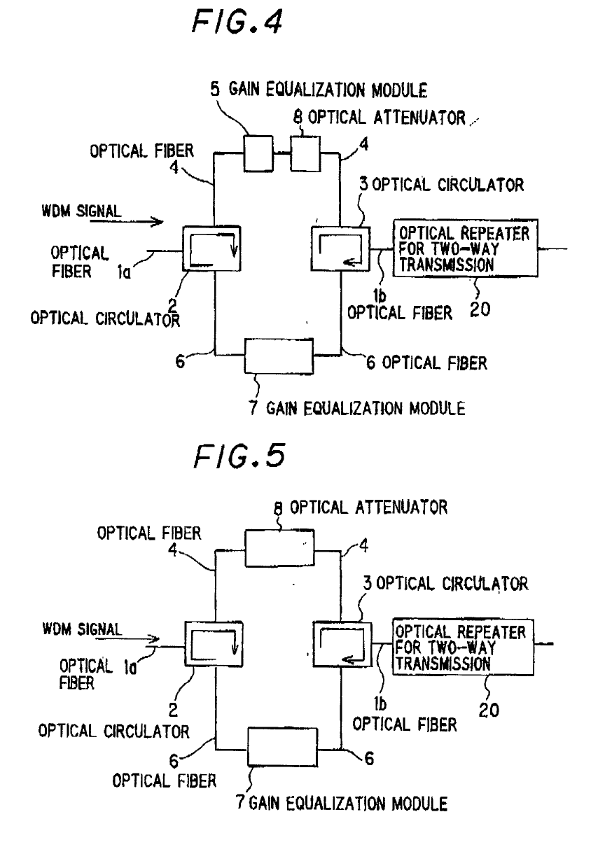

FIG. 4 shows a first embodiment of the application of the gain equalizer for two-way transmission according to the invention.

An optical repeater 20 for two-way transmission is provided within the optical fiber 1b on the downstream side in the gain equalizer 10 for two-way transmission shown in FIG. 2. Further, in the gain equalizer 10 for two-way transmission, an optical ATT (an optical attenuator) B is connected in series to the gain equalization module 5.

In FIG. 4, when the WDM signal SWDM from the upstream side is smaller than a specific input power, the power output from the optical repeater 20 for two-way transmission is smaller than a specific value, leading to a gradient of WDM signal SWDM. Accordingly, for the WDM signal SWDM which has passed through the gain equalization module 5, the level of attenuation by the optical ATT 8 is lowered, and the signal level of the WDM signal SWDM input into the optical repeater 20 for two-way transmission through the optical circulator 2 is increased.

On the other hand, when the WDM signal SWDM from the upstream side is larger than a specific input power, the power output from the optical repeater 20 for two-way transmission is larger than a specific value, here again leading to a gradient of WDM signal SWDM. Accordingly, for the WDM signal SWDM which has passed through the gain equalization module 5, the level of attenuation by the optical ATT 8 is increased, and the signal level of the WDM signal SWDM input into the optical repeater 20 for two-way transmission through the optical circulator 2 is lowered.

Thus, the regulation of the attenuation level of the optical ATT 8 can bring the power input into the optical repeater 20 for two-way transmission to a specific power, and the gradient of the WDM signal SWDM output from the optical repeater 20 for two-way transmission can be corrected.

In the construction shown in FIG. 4, the optical ATT 8 is provided on the gain equalization module 5 side. Alternatively, the optical ATT 8 may be provided on the gain equalization module 7 side. Further, the optical ATT 8 may be provided in both the gain equalization module 5 and the gain equalization module 7. The optical repeater 20 for two-way transmission may be provided on the optical fiber 1a side, or alternatively may be provided in both the gain equalization modules 5, 7.

FIG. 5 shows a second embodiment of the application of the gain equalizer for two-way transmission according to the invention.

The construction shown in FIG. 5 is the same as that shown in FIG. 4, except that the gain equalization module 5 has been removed. As with FIG. 4, the optical repeater 20 for two-way transmission is provided within the optical fiber 1b on the downstream side of the gain equalizer 10 for two-way transmission. Also in this case, as with FIG. 4, when the input power of the WDM signal SWDM introduced into the optical circulator 2 is excessively large or excessively small for the optical repeater 20 for two-way transmission, the optical ATT 8 is regulated to optimize the output power of the optical repeater 20 for two-way transmission. This can realize the correction of the gradient of the WDM signal SWDM output from the optical repeater 20 for two-way transmission. The optical ATT 8 may be provided within the optical fiber 6 in FIG. 3A.

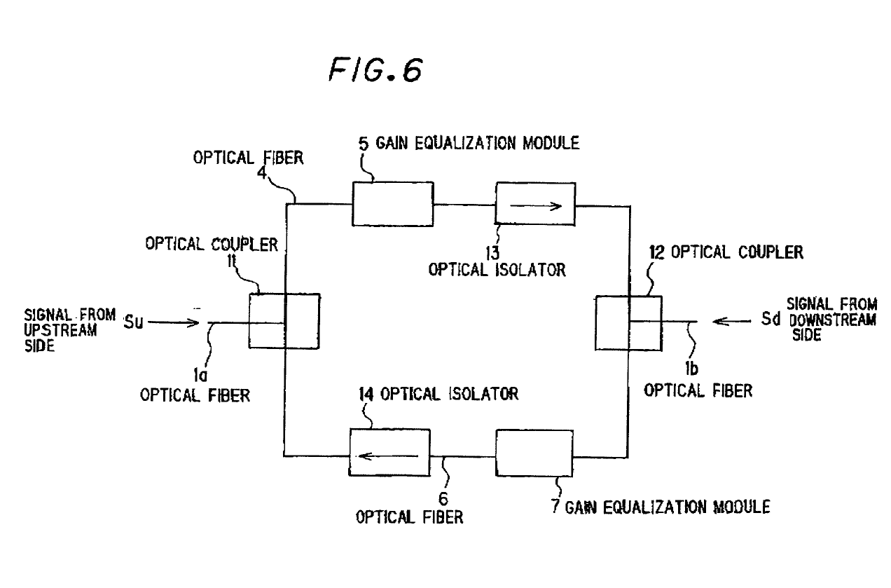

FIG. 6 shows another preferred embodiment of the invention.

In this preferred embodiment, optical couplers 11, 12 are used instead of the optical circulators 2, 3 shown in FIG. 2, an optical isolator 13 is connected between the gain equalization module 5 and the optical coupler 12, and an optical isolator 14 is connected between the gain equalization module 7 and the optical coupler 11. The optical isolators 13 and 14 functions to permit the transmission of an optical signal in only one direction and to block an optical signal from the opposite direction. According to this construction, the gain equalizer for two-way transmission, i.e., upstream and downstream directions, can be constructed without any optical circulator.

In FIG. 6, as with FIG. 3, the gain equalization module may be provided in only any one of the optical fibers 4 and 6. The optical ATT 8 shown in FIG. 4 may be connected to at least one of the gain equalization modules 5 and 7. Further, the optical ATT 8 shown in FIG. 5 may be replaced with the gain equalization module 5 or 7. The effect attained in this case is as explained above in connection with FIGS. 4 and 5.

In FIG. 6, a signal Su from the upstream side enters the gain equalization module 5 through the optical coupler 11. The signal Su, which has been gain equalized by the gain equalization module 5, is passed through the optical isolator 13, is introduced into the optical coupler 12, and is then sent to the optical fiber 1b. A signal Sd from the downstream side enters the gain equalization module 7 through the optical coupler 12. The signal Sd, which has been gain equalized by the gain equalization module 7, is passed through the optical isolator 14, is introduced into the optical coupler 11, and is then sent to the optical fiber 1a.

Thus, also in the construction shown in FIG. 6, gain equalization for upstream signals and gain equalization for downstream signals in a single transmission path (optical fiber) can be carried out independently of each other, and the gradient of the WDM signal can be corrected.

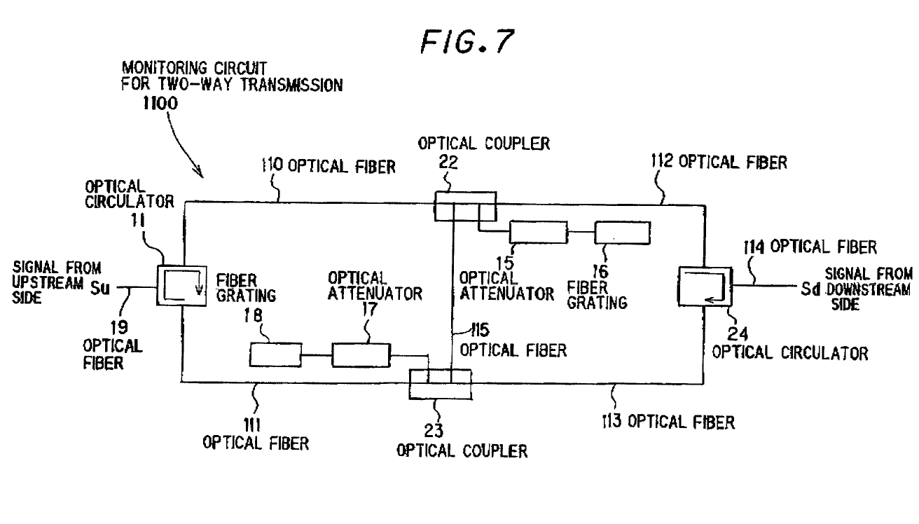

FIG. 7 shows a first preferred embodiment of the monitor circuit for two-way transmission according to the invention.

A monitor circuit 1100 for two-way transmission according to the invention is provided along an optical transmission path of an optical fiber. This monitor circuit 1100 for two-way transmission comprises an optical circulator 11, optical couplers 22, 23, an optical circulator 24, an optical ATT 15, a fiber grating 16, an optical ATT 17, a fiber grating 16, and optical fibers 19, 110, 111, 112, 113, 114, 115.

The optical coupler 22 is connected to the output terminal of the optical circulator 11, and the optical coupler 23 is connected to the input terminal of the optical circulator 11. The optical circulator 24 is connected to the optical coupler 22 and the optical coupler 23. The optical ATT (optical attenuator) 15 is connected to the optical coupler 22, and the fiber grating 16 as a wavelength filter is connected to the optical ATT 15. The optical ATT 17 is connected to the optical coupler 23. The fiber grating 18 is connected to the optical ATT 17. When a monitor signal and other optical signal are simultaneously transmitted, the optical ATT 15 and the optical ATT 17 function to reduce the influence of the returned monitor signal on other optical signal and thus to prevent deformation and the like.

When monitoring is performed, a monitor signal Su is sent from the upstream side and is introduced into the monitor circuit 1100 for two-way transmission, while a monitor signal Sd is sent from the downstream side. The monitor signal Su and the monitor signal Sd are different from upstream and downstream signals in wavelength from the viewpoint of performing monitoring without influence on signals. The wavelength of the fiber grating 16 is set at the wavelength of the monitor signal Su, and the wavelength of the fiber grating 18 is set at the wavelength of the monitor signal Sd.

The optical circulator 11 is connected to a sending station (a sending source) (not shown) on the upstream side, such as a terminal station, through the optical fiber 19 as the optical transmission path. The optical circulator 11 is connected to the optical coupler 22 through the optical fiber 110. The optical circulator 11 is connected to the optical coupler 23 through the optical fiber 111. The optical coupler 22 is connected to the optical circulator 24 through the optical fiber 112. The optical coupler 23 is connected to the optical circulator 24 through the optical fiber 113. Further, the optical circulator 24 is connected to the sending station (not shown) on the downstream side through the optical fiber 114. The optical coupler 22 is connected to the optical coupler 23 through the optical fiber 115 as an optical transmission path for coupler connection (bypass line).

Next, the operation of the monitor circuit for two-way transmission having the above construction will be explained. Monitoring on the upstream side will be first explained. The monitor signal Su on the upstream side constituted by an optical signal with a predetermined wavelength is sent from the sending station, such as a terminal station, and is introduced through the optical fiber 19 into the optical circulator 11. The monitor signal Su introduced into the optical circulator 11 is sent through the optical fiber 110 to the optical coupler 22 and further enters the optical ATT 15. The monitor signal Su is attenuated in the optical ATT 15, is then sent to the fiber grating 16, and is reflected from the fiber grating 16. The monitor signal Su from the fiber grating 16 is again introduced into the optical ATT 15 and is again attenuated. The monitor signal Su from the optical ATT 15 is introduced into the optical circulator 11 through a path of optical coupler 22→optical fiber 115→optical coupler 23. The monitor signal Su introduced into the optical circulator 11 is transmitted in an opposite direction through the optical fiber 19 and is returned to the sending station. The sending station detects the returned monitor signal Su to monitor the status of the upstream transmission path.

Next, monitoring on the downstream side will be explained. The monitor signal Sd from the sending station on the downstream side constituted by an optical signal with a predetermined wavelength introduced through the optical fiber 114 into the optical circulator 24. The monitor signal Sd introduced into the optical circulator 24 enters the optical coupler 23 through the optical fiber 113 and is sent from the optical coupler 23 to the optical ATT 17. The monitor signal Sd is attenuated in the optical ATT 7, is then sent to the fiber grating 18, and is reflected from the fiber grating 18. The monitor signal Sd reflected from the fiber grating 18 is again introduced into the optical ATT 17 and is again attenuated in the optical ATT 17. The monitor signal Sd from the optical ATT 17 is introduced into the optical circulator 24 through a path of optical coupler 23→optical fiber 115→optical coupler 22, is transmitted in the opposite direction through the optical fiber 114, and is returned to the sending station of the monitor signal Sd. The sending station detects the returned monitor signal Sd to monitor the status of the downstream transmission path.

Thus, this preferred embodiment of the invention can realize monitoring in a communication system for two-way transmission using an identical fiber. Further, the monitor circuit for two-way transmission according to the invention can be installed in any place (or in any place of distance) in the transmission path for two-way transmission.

In the above construction, when the monitor signal Su and the monitor signal Sd are made different from each other in wavelength and, in addition, the fiber grating 16 and the fiber grating 18 are made different from each other in wavelength, monitoring the upstream transmission path and monitoring the downstream transmission path can be simultaneously carried out.

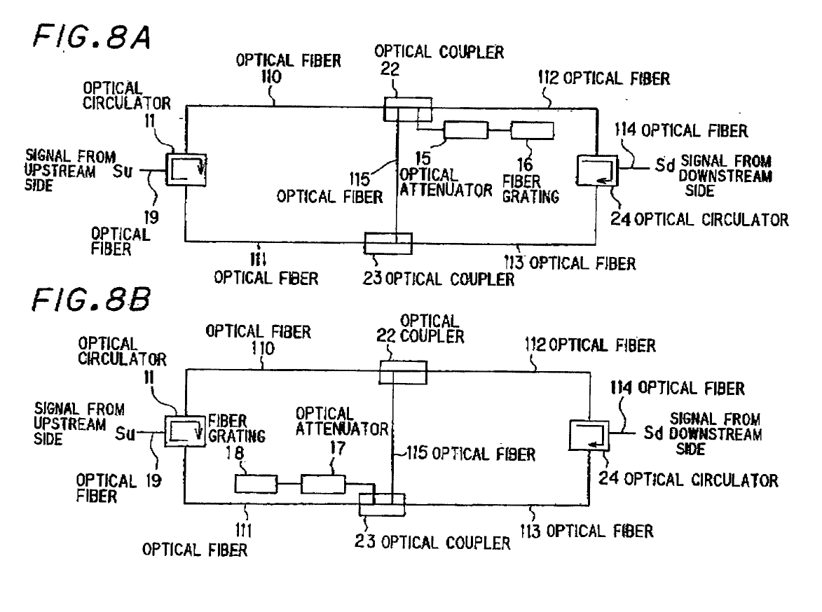

FIG. 8 shows a variant of the monitor circuit for two-way transmission shown in FIG. 7. In FIG. 8A, monitoring only the upstream side is contemplated, and the construction shown in FIG. 8A is the same as that shown in FIG. 7, except that the optical ATT 17 and the fiber grating 18 have been removed. On the other hand, in FIG. 8B, monitoring only the downstream side is contemplated, and the construction shown in FIG. 8B is the same as that shown in FIG. 7, except that the optical ATT 15 and the fiber grating 16 have been removed. The operation of both the constructions shown in FIGS. 8A and 8B are as described above in connection with the first preferred embodiment of the monitor circuit according to the invention. In the above explanation, the optical ATTs 15, 17 are omitted, and the passage of the optical fiber 115 is replaced with the optical ATT 130.

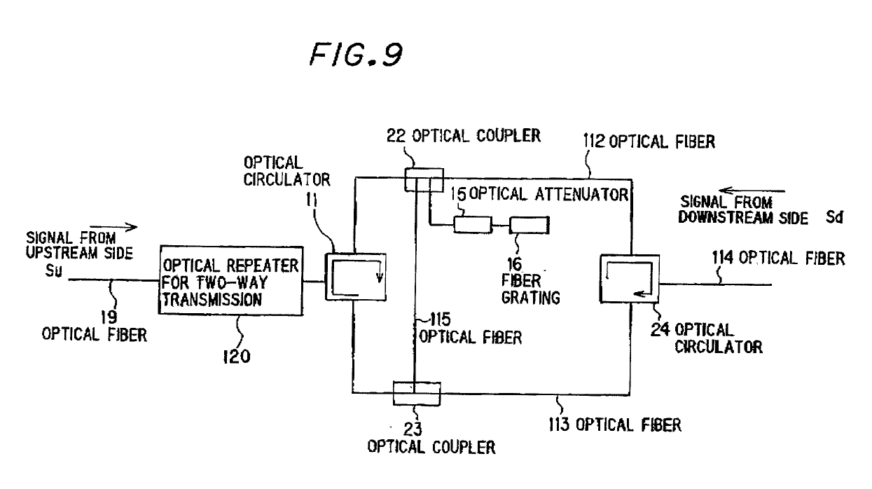

FIG. 9 shows an embodiment of the application of the monitor circuit for two-way transmission according to the invention.

FIG. 9 illustrates the application of the monitor circuit for two-way transmission according to the invention to an optical repeater. An optical repeater 120 for two-way transmission is connected within the optical fiber 19, that is, on the upstream side of the monitor circuit 1100 for two-way transmission according to the invention, and the monitor circuit 1100 for two-way transmission can monitor the output of the two-way repeater 120.

In FIG. 9, the output of an upstream monitor signal Su, which has passed through the optical repeater 120 for two-way transmission, passes through the optical circulator 11, the optical fiber 110, and the optical coupler 22 and enters the optical ATT 15. The monitor signal Su, which has been attenuated in the optical ATT 15, enters the fiber grating 16 and is then reflected from the fiber grating 16. The reflected monitor signal Su is again introduced into the optical ATT 15 and is here again attenuated. The monitor signal Su from the optical ATT 15 is introduced into the optical coupler 22 and enters the optical coupler 23 through the optical fiber 115. In the optical coupler 23, the monitor signal Su from the optical coupler 22 is multiplexed with the downstream signal from the optical circulator 24. The multiplexed signal is introduced through the optical circulator 11 into the optical repeater 120 for two-way transmission and is sent from the optical repeater 120 for two-way transmission to the sending station on the upstream side. The sending station on the upstream side detects the optical signal from the optical repeater 120 for two-way transmission to monitor the output of the optical repeater 120 for two-way transmission. When the optical repeater is also provided in the previous stage of the optical repeater 120 for two-way transmission, monitoring also this optical repeater is possible.

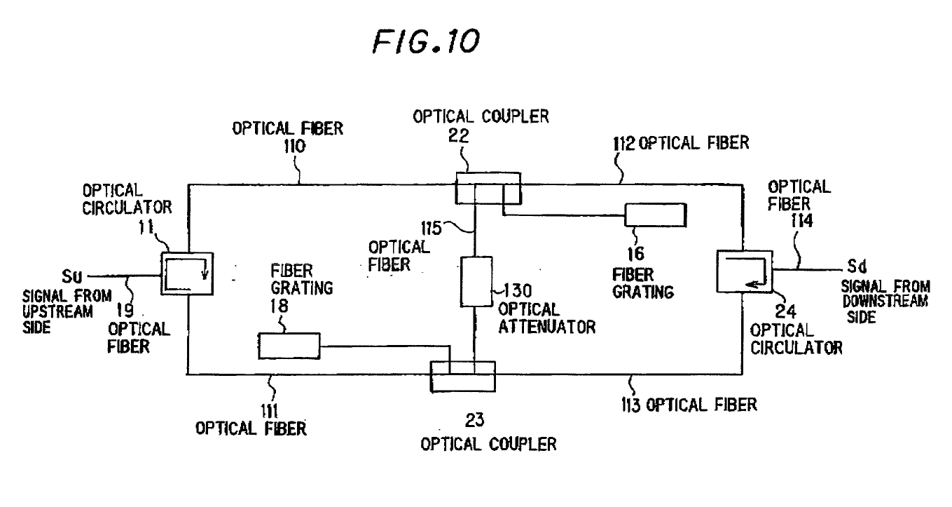

FIG. 10 shows a second preferred embodiment of the monitor circuit for two-way transmission.

This preferred embodiment is characterized in that, in the construction shown in FIG. 7, the optical ATT 15 and the optical ATT 17 have been removed and the optical ATT 130 is provided within the optical fiber 115. Since the optical ATT 130 serves as the optical ATT 15 and the optical ATT 17 in FIG. 7, the number of optical ATT can be reduced to one in FIG. 10, whereas, in FIG. 7, two optical ATTs are necessary. This can reduce the cost, and, by the number of optical ATT reduced, the mounting space can be reduced and the reliability can be improved. A method may also be adopted wherein, without the insertion of the optical ATT, the ratio of branch to the fiber gratings 15, 16 in the optical couplers 22, 23 is lowered.

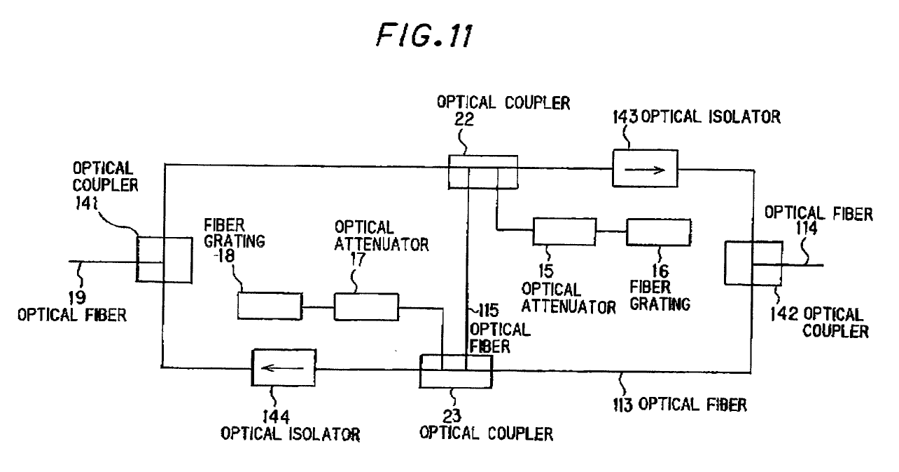

FIG. 11 shows a third preferred embodiment of the monitor circuit for two-way transmission according to the invention.

This preferred embodiment is characterized in that, the construction shown in FIG. 7, optical couplers 141, 142 are provided instead of the optical circulators 11, 24 and, in addition, optical isolators 143, 144 are provided instead of the optical fibers 112, 111. This construction can realize two-way monitoring.

The operation of the monitor circuit 1100 for two-way transmission having the construction shown in FIG. 11 will be explained. Here an upstream monitor signal Su and a general transmission optical signal are simultaneously sent from the upstream side through the optical fiber 19 to the monitor circuit for two-way transmission. The general optical signal and the monitor signal Su from the upstream side enter the optical coupler 141. In this case, the general optical signal reaches the optical circulator 24 through a path of optical coupler 141→optical fiber 110→optical coupler 22→optical isolator 143 and is transmitted to the downstream terminal station.

On the other hand, as with FIG. 7, the monitor signal Su introduced into the optical coupler 141 is returned to the optical coupler 22 through a path of optical fiber 110→optical coupler 22→optical ATT 15→fiber grating 16→reflection→optical ATT 15, is then passed through a path of optical fiber 115→optical coupler 23→optical isolator 144→optical fiber 111→optical coupler 141, and is returned to the sending station through the optical fiber 19. This monitor signal Su can be used to monitor the system, for example, for breaking of the optical fiber on the upstream side.

Next, on the downstream side, a downstream monitor signal Sd and a general transmission optical signal are simultaneously sent from the downstream side to the monitor circuit 1100 for two-way transmission. The general optical signal and the monitor signal Sd from the downstream side enter the optical coupler 142 through the optical fiber 114. In this case, the general optical signal reaches the optical circulator 24 through a path of optical coupler 142→optical fiber 113→optical coupler 23→optical isolator 144→optical fiber 111 and is transmitted toward the terminal station on the upstream side.

On the other hand, the monitor signal Sd introduced into the optical coupler 142 is returned to the optical coupler 23 through a path of optical fiber 113→optical coupler 23→optical ATT 17→fiber grating 18→reflection→optical ATT 17, is then passed through a path of optical fiber 115→optical coupler 22→optical isolator 143→optical coupler 142, and is returned to the sending station on the downstream side through the optical fiber 114. This monitor signal Sd can be used to monitor, for example, the breaking of the optical fiber on the downstream side.

Thus, according to the preferred embodiment shown in FIG. 11, two-way monitoring can be performed while simultaneously transmitting upstream and downstream signals.

In the above preferred embodiments, the transmission path is an optical fiber. Alternatively, an optical waveguide may be used as the transmission path. Further, the optical repeater 120 shown in FIG. 9 may be provided in the constructions shown in FIGS. 8, 10, and 11.

As is apparent from the foregoing description, in the first gain equalizer for two-way transmission according to the invention, first and second circulators are provided in series along an optical transmission path, and a gain equalization circuit is inserted into at least one of an upstream path and a downstream path formed between the first and second circulators to return the spectrum of all channels of WDM signals passed through the gain equalization circuit to a horizontal state. By virtue of this construction, the spectrum characteristics of all channels of WDM signals in two-way transmission, wherein upstream and downstream signals are transmitted using an identical optical fiber, can be rendered identical.

Further, in the second gain equalizer for two-way transmission according to the invention, first and second optical couplers are provided in series along an optical transmission path, and a gain equalization circuit is inserted through an optical isolator into at least one of an upstream path and a downstream path formed between both the first and second optical couplers to return the spectrum of all channels of WDM signals passed through the gain equalization circuit to a horizontal state. By virtue of this construction, the spectrum characteristics of all channels of WDM signals in two-way transmission, wherein upstream and downstream signals are transmitted using an identical optical fiber, can be rendered identical.

In the first monitor circuit for two-way transmission according to the invention, a monitor signal introduced into an optical circulator enters a wavelength filter, is reflected from the wavelength filter, is passed through a plurality of optical couplers, and is returned to the sending station through the optical circulator into which the signal has been initially input. This construction can realize monitoring in two-way transmission using an identical optical transmission path common to upstream and downstream signals.

In the second monitor circuit for two-way transmission according to the invention, the monitor signal, which has entered the first optical circulator, enters the first wavelength filter through the first optical coupler. The monitor signal reflected from the wavelength filter is returned to the first optical filter, enters the second optical coupler through the optical attenuator, and is then returned to the first circulator. Likewise, the monitor signal, which has entered the second circulator, enters the second optical wavelength filter through the second optical coupler. The monitor signal reflected from this wavelength filter is returned to the second optical coupler, enters the first optical coupler through the optical attenuator, and is then returned to the second optical circulator. This can realize the monitoring in two-way communication using an identical optical transmission path common to upstream and downstream signals.

Further, in the third monitor circuit for two-way transmission according to the invention, optical couplers are provided instead of the first and second optical circulators in the first monitor circuit for two-way transmission, and first and second optical isolators are provided within the optical transmission paths through which monitor signals are returned to these optical couplers. Optical signals other than the monitor signal are transmitted through the optical isolator to the downstream side or next stage. This construction permits two-way monitoring to be performed in two-way communication using an identical optical transmission path common to upstream and downstream signals while simultaneously transmitting upstream and downstream signals.

The invention has been described in detail with particular reference to preferred embodiments, but it will be understood that variations and modifications can be effected within the scope of the invention as set forth in the appended claims.

What is claimed is:

1. A gain equalizer for two-way transmission, comprising:
first and second circulators which are common to upstream and downstream signals, are provided in series along an optical transmission path through which an optical signal is transmitted in two directions and partially constitute an upstream path and a downstream path; and
a gain equalization circuit which has been inserted into at least one of the upstream and downstream paths and equalizes the characteristics of all of channels of WDM (wavelength division multiplexing) signals passed therethrough.

2. The gain equalizer for two-way transmission according to claim 1, wherein the gain equalization circuit is inserted into each of the first and second paths.

3. The gain equalizer for two-way transmission according to claim 2, wherein one of the gain equalization circuits is an optical attenuator.

4. The gain equalizer for two-way transmission according to claim 1, wherein an optical attenuator is connected to the gain equalization circuit.

5. A gain equalizer for two-way transmission, comprising:
first and second optical couplers which are common to signals from upstream and downstream sides, are provided in series along an optical transmission path through which an optical signal is transmitted in two directions and partially constitute an upstream path and a downstream path;
a gain equalization circuit which has been inserted into at least one of the upstream and downstream paths and equalizes the characteristics of all of channels of WDM (wavelength division multiplexing) signals passed therethrough;
a first optical isolator inserted into the upstream path; and
a second optical isolator inserted into the downstream path.

6. A monitor circuit for two-way transmission, comprising:
first and second optical circulators which are common to upstream and downstream signals and are inserted in series along an optical transmission path through which an optical signal is transmitted in two directions and, at a predetermined time, a monitor signal is transmitted;
first and second optical couplers which are provided in parallel between the first and second optical circulators and are inserted respectively into an upstream transmission path and a downstream transmission path;
an optical transmission path for coupler connection which is connected between the first and second optical couplers to constitute a bypass path; and
a wavelength filter which is connected to the first optical coupler or the second optical coupler and reflects light with the wavelength of the monitor signal.

7. The monitor circuit for two-way transmission according to claim 6, wherein the optical attenuator and the wavelength filter are provided in each of the first and second optical couplers.

8. The monitor circuit for two-way transmission according to claim 6 or 7, wherein the optical attenuator is provided between the wavelength filter and the first or second optical coupler.

9. The monitor circuit for two-way transmission according to claim 6 or 8, wherein the wavelength filter is a fiber grating.

10. The monitor circuit for two-way transmission according to claim 6, wherein the optical transmission path common to the upstream and downstream signals is an optical fiber.

11. A monitor circuit for two-way transmission, comprising:
first and second optical circulators which are common to upstream and downstream signals and are inserted in series along an optical transmission path through which an optical signal is transmitted in two directions and, at a predetermined time, a monitor signal is transmitted:
first and second optical couplers which are provided in parallel between the first and second optical circulators and are inserted respectively into an upstream transmission path and a downstream transmission path;
an optical attenuator provided between the first and second optical couplers; and
first and second wavelength filters which are connected respectively to the first and second optical couplers and reflect light with the wavelength of the monitor signal.

12. The monitor circuit for two-way transmission according to claim 11, wherein the first and second wavelength filters each are a fiber grating, and
the optical transmission path common to upstream and downstream signals is an optical fiber.

13. A monitor circuit for two-way transmission, comprising:
first and second optical couplers which are common to upstream and downstream signals and are inserted in series along an optical transmission path through which an optical signal is transmitted in two directions and, at a predetermined time, a monitor signal is transmitted;
third and fourth optical couplers which are provided in parallel between the first and second optical circulators and are inserted respectively into an upstream transmission path and a downstream transmission path;
an optical transmission path for coupler connection which is connected between the first and second optical couplers to constitute a bypass path;
a first optical isolator inserted into between the third optical coupler and the second optical coupler;
a second optical isolator inserted into between the fourth optical coupler and the first optical coupler:
first and second optical attenuators connected respectively to the third optical coupler and the fourth optical coupler; and
first and second wavelength filters which are connected respectively to the first and second optical attenuators and reflect light with the wavelength of the monitor signal.

14. The monitor circuit for two-way transmission according to claim 13, wherein the first and second wavelength filters each are a fiber grating, and
the optical transmission path common to upstream and downstream signals is an optical fiber.
